(19) United States
(12) Patent Application Publication
(10) Pub. No.: US 2019/0317602 A1
(43) Pub. Date: Oct. 17, 2019

(54) TOUCH INPUT DEVICE

(71) Applicant: SUNREX TECHNOLOGY CORP., Taichung City (TW)

(72) Inventors: Chun-Chieh CHEN, Taichung City (TW); Ching-Yao HUANG, Taichung City (TW); Ling-Cheng TSENG, Taichung City (TW)

(73) Assignee: SUNREX TECHNOLOGY CORP., Taichung City (TW)

(21) Appl. No.: 16/113,322

(22) Filed: Aug. 27, 2018

(30) Foreign Application Priority Data
Apr. 13, 2018 (TW) 107112823

(51) Int. Cl. G06F 3/01; G06F 1/16; G06F 3/0354

(52) U.S. Cl. CPC G06F 3/016; G06F 1/1616; G06F 3/03547; G06F 1/1662

(57) ABSTRACT

A touch input device includes a base board unit and an upper board unit. The base board unit includes opposite side ribs, opposite top and bottom surfaces, an intermediate portion disposed at the middle of one side rib, two flanking portions flanking the intermediate portion and two slots formed respectively through the flanking portions. The base board unit includes two resilient arms extending from the intermediate portion into the slots, respectively. The upper board unit is disposed on and above the base board unit and includes opposite sides correspond respectively in position to the side ribs, and two touch sensing modules respectively correspond in position to and spaced apart from the resilient arms.

### CROSS-REFERENCE TO RELATED APPLICATION

This application claims priority of Taiwanese Patent Application No. 107112823, filed on Apr. 13, 2018.

### FIELD

The disclosure relates to an electronic device, and more particularly to a touch input device for a mobile electronic device.

### BACKGROUND

A notebook computer is usually equipped with a keyboard and a touchpad or a trackpad to serve as input interfaces. Generally, a touchpad substitutes for a mouse and includes a touch sensing surface capable of translating a motion and position of a user's fingers to relative positions to be displayed as a cursor, and a plurality of clickable buttons serving as right, left and center buttons of a mouse.

Taiwanese Invention Patent No. 1535366 discloses a supporting device for supporting a touch sensing unit of a notebook. The supporting device includes a bottom frame and a supporting plate mounted slantly in the bottom frame and having two opposite ends that abut against the frame. The touch sensing unit is supported by and disposed on the supporting plate. When an external force is exerted on the touch sensing unit, a touched portion of the touch sensing unit is moved into contact with the supporting plate to counteract a biasing force provided by the supporting plate which serves as a sense of tactile to the user. At this time, the touch sensing unit outputs a click signal indicating a touched position on the touch sensing unit. However, when a side portion of the supporting plate that corresponds in position to the touched portion is pressed by the touched portion to move downwardly, an opposite side portion of the supporting plate may move upwardly and undesirably come into contact with the touch sensing unit such that the touch sensing unit may erroneously output the click signal.

### SUMMARY

Therefore, an object of the disclosure is to provide a touch input device that can alleviate the drawback of the prior art.

According to the disclosure, a touch input device includes a base board unit and an upper board unit. The base board unit includes a first side rib, a second side rib, a top surface, a bottom surface, an intermediate portion, two flanking portions and two slots. The first side rib extends in a first direction. The second side rib extends in the first direction and is opposite to the first side rib in a second direction transverse to the first direction. The top surface and the bottom surface are opposite to each other. The intermediate portion is disposed at a middle portion of the second side rib. The flanking portions flank the intermediate portion and are opposite to each other in the first direction. The slots extend through the top surface and the bottom surface and are formed respectively through the flanking portions. The base board unit includes two resilient arms, each of which extends from the intermediate portion into a corresponding one of the two slots.

The upper board unit is disposed on and above the base board unit and includes a first side, a second side and a pair of touch sensing modules. The first side of the upper board unit is connected to the first side rib of the base board unit. The second side of the upper board unit corresponds in position to the second side rib of the base board unit and is movable relative to the second side rib of the base board unit. The touch sensing modules respectively correspond in position to and are spaced apart from the resilient arms. When an external force is exerted on one of the touch sensing modules, the one of the touch sensing modules is moved into contact with a corresponding one of the resilient arms such that the other one of the resilient arms supports the other one of the touch sensing modules by resilient deformation.

### BRIEF DESCRIPTION OF THE DRAWINGS

Other features and advantages of the disclosure will become apparent in the following detailed description of the embodiment with reference to the accompanying drawings, of which:

FIG. 1 is a partly sectional, exploded perspective view of a touch input device according to an embodiment of the present disclosure;

FIG. 2 is a fragmentary enlarged view of a base board unit of the touch input device;

FIG. 3 is a sectional view of the touch input device;

FIG. 4 is another sectional view taken along line IV-IV in FIG. 3;

FIG. 5 is a sectional view similar to FIG. 4, illustrating an external force being exerted on the touch input device;

FIG. 6 illustrates two plots representing response curves of a conventional touch input device; and

FIG. 7 illustrates two plots representing response curves of the touch input device of the present disclosure.

### DETAILED DESCRIPTION

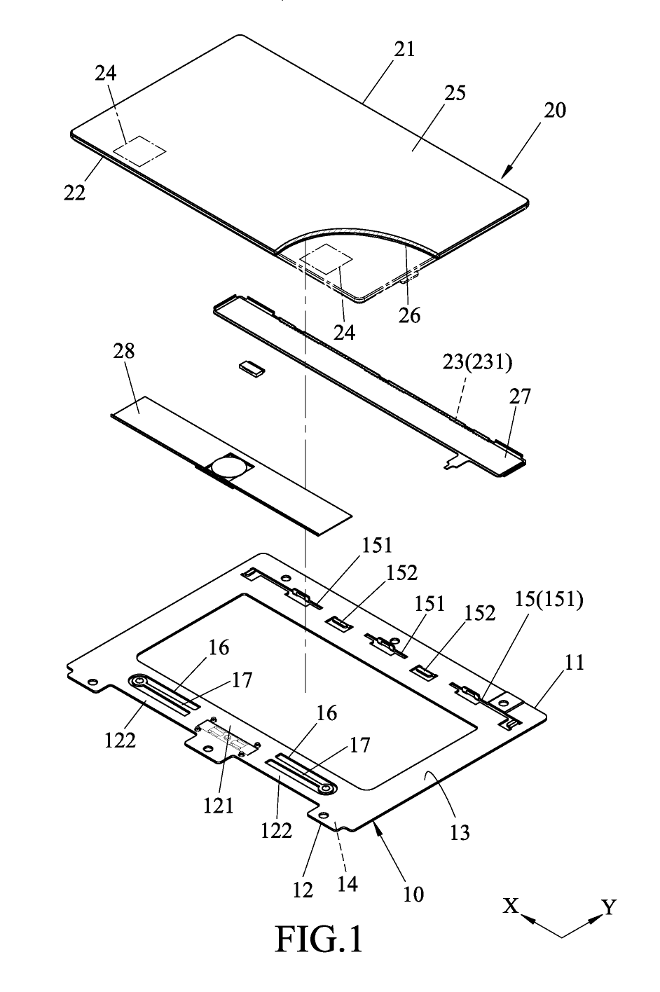

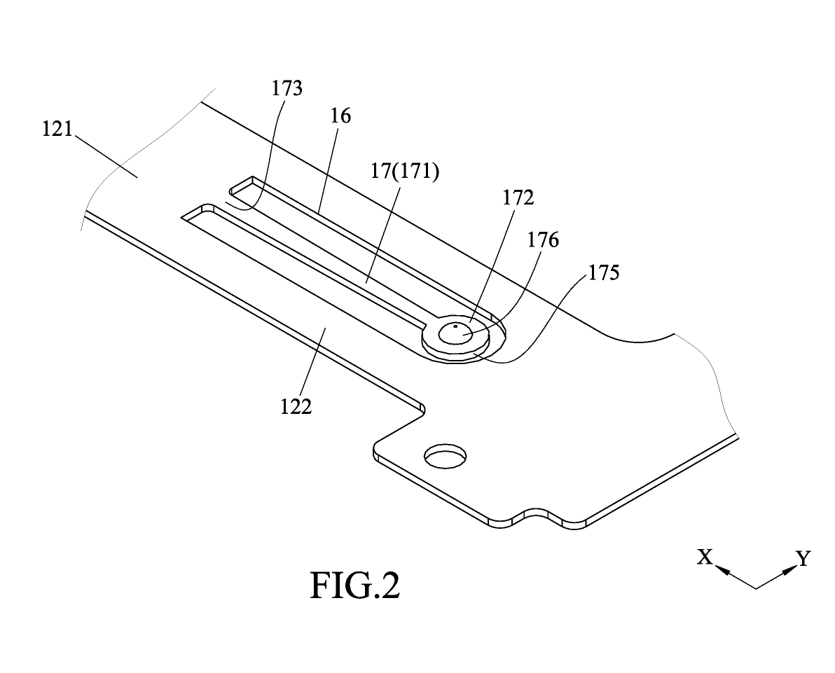

Referring to FIGS. 1 and 2, an embodiment of a touch input device according to the disclosure to be mounted on a notebook (not shown) and serving as input device of the notebook is provided. The touch input device includes a base board unit 10 and an upper board unit 20.

The base board unit 10 includes a first side rib 11 extending in a first direction (X), a second side rib 12 extending in the first direction (X) and opposite to the first side rib 11 in a second direction (Y) transverse to the first direction (X), a top surface 13, a bottom surface 14 opposite to each other, a lower connecting portion 15 disposed adjacent to the first side rib 11, an intermediate portion 121 disposed at a middle portion of the second side rib 12, two flanking portions 122 flanking the intermediate portion 121 and opposite to each other in the first direction (X), two slots 16 extending through the top surface 13 and the bottom surface 14 and formed respectively through the flanking portions 122, and two resilient arms 17, each of which extends from the intermediate portion 121 into a corresponding one of the two slots 16. The slots 16 and the resilient arms 17 extend in the first direction (X). The lower connecting portion 15 is formed with three through holes 151 spaced apart from one another in the first direction (X) and extending through the top surface 13 and the bottom surface 14 and two supporting seats 152 spaced apart from each other in the first direction (X) and each disposed between two adjacent ones of the through holes 151.

Each of the resilient arms 17 includes a connecting end 173 connected to and extending from the intermediate portion 121, an elongated plate segment 171 extending from the connecting end 173, and a contact segment 172 extending from the elongated plate segment 171, having a free end opposite to the connecting end 173, and a dimension greater than that of the elongated segment 171 in the second direction (Y). For each of the resilient arms 17, the contact segment 172 has a circular plate portion 175 extending from and coplanar with the elongated plate segment 171, and a protrusion 176 upwardly extending from circular plate portion 175.

The upper board unit 20 is disposed on and above the base board unit 10, and includes a top layer 25, a first side 21, a second side 22, a circuit board module 26, an upper connecting portion 23, two touch sensing modules 24, a rear supporting plate 27 and a front supporting plate 28. The first side 21 is connected to the first side rib 11 of the base board unit 10. The second side 22 corresponds in position to the second side rib 12 of the base board unit 10 and is movable relative to the second side rib 12 of the base board unit 10. The circuit board module 26 is disposed under the top layer 25 and the touch sensing modules 24 are disposed in the circuit board module 26. The touch sensing modules 24 respectively correspond in position to and are spaced apart from the resilient arms 17. The rear supporting plate 27 and the front supporting plate 28 are disposed under the circuit board module 26 and are respectively adjacent to the first side 21 and the second side 22 such that the touch sensing modules 24 are positioned between the front supporting plate 28 and the top layer 25. The upper connecting portion 23 is disposed on the rear supporting plate 27, and includes a plurality of insertion fins 231 spaced apart from one another in the first direction (X) and extending respectively into the through holes 151 of the lower connecting portions 15 of the base board unit 10 such that the upper board unit 20 is connected fixedly to the base board unit 10. Further, the rear supporting plate 27 is disposed on and abuts against the supporting seats 152 of the lower connecting portion 15 such that the supporting seats 152 serve as pivot point of movement of the second side 22 relative to the base board unit 10. The protrusion 176 of each of the resilient arms 17 extends toward a corresponding one of the touch sensing modules 24 for contact therewith.

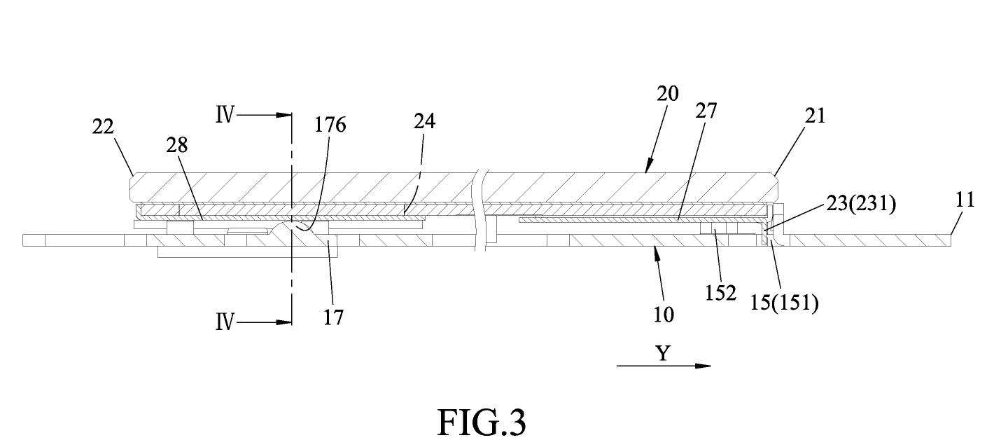

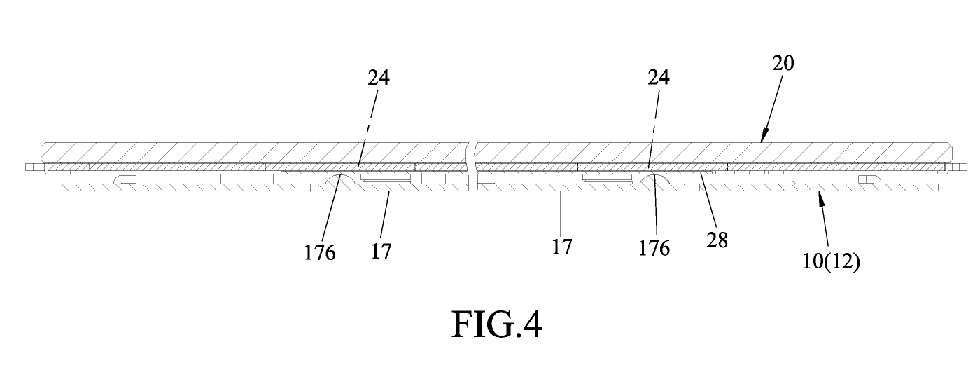

Further referring to FIGS. 3 to 5, how the abovementioned structures operate will be described. As shown in FIGS. 3 and 4, when no external force is exerted on the touch sensing modules 24, the second side 22 of the upper board unit 20 is spaced apart from the second side rib 12 of the base board unit 10 and the protrusion 176 of each of the resilient arms 17 is free of contact with the corresponding one of the touch sensing modules 24.

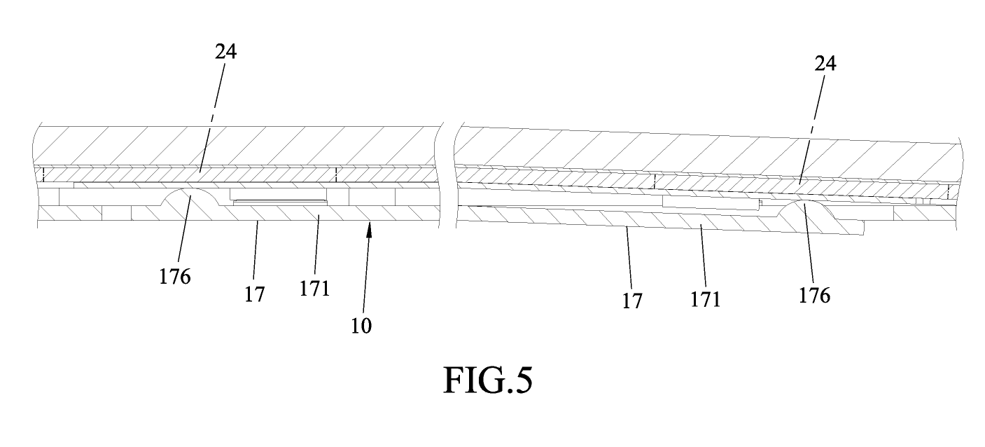

As shown in FIG. 5, when an external force is exerted on a right portion of the upper board unit 20 corresponding in position to the right one of the touch sensing modules 24, which represents a right click operation of a mouse for the notebook mounted with the touch input device, the right touch sensing module 24 is moved into contact with the protrusion 176 of the corresponding one of the resilient arms 17 to output a signal indicating a right click of the mouse to the notebook. At this time, a left portion of the base board unit 10 may be moved in an upward direction opposite to a downward direction of the right portion of the base board unit 10 being pressed and the protrusion 176 of the other one of the resilient arms 171 supports the left one of the touch sensing modules 24 by resilient deformation thereof without triggering the left touch sensing module 24 to output a signal indicating a left click of the mouse. Similarly, when an external force is exerted on the left portion of the upper board unit 20, which represents a left click operation of a mouse, the left touch sensing module 24 is brought into contact with the protrusion 176 of the left one of the resilient arms 171 to output a signal indicating a left click of the mouse, and the right resilient arm 171 resiliently deforms to support the right touch sensing module 24 without triggering the right touch sensing module 24. In this way, the touched one of the touch sensing modules 24 outputs a signal indicating an accurate position of touch without erroneously triggering the other one of the touch sensing module 224.

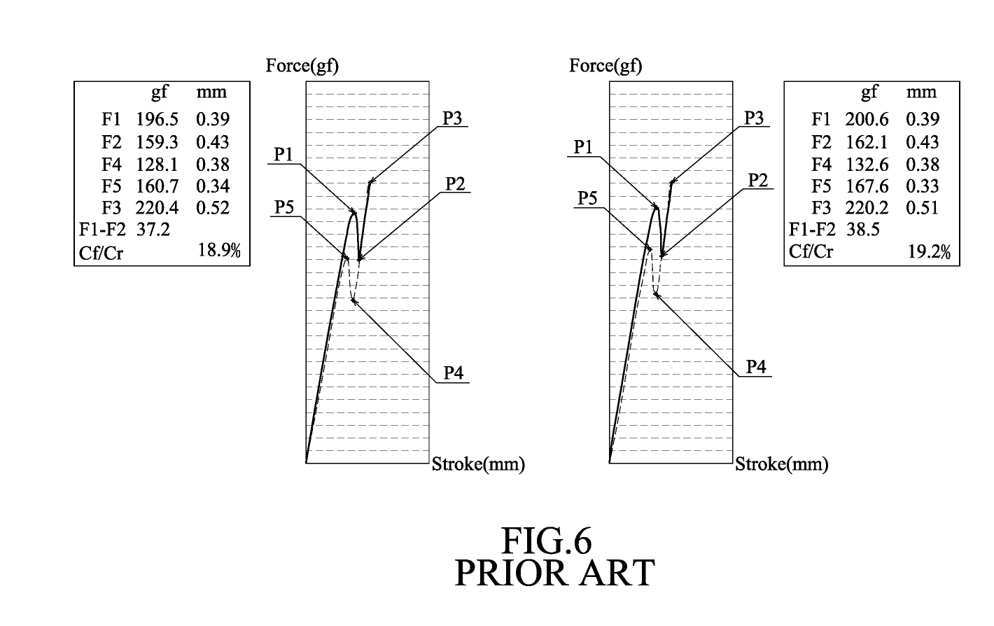

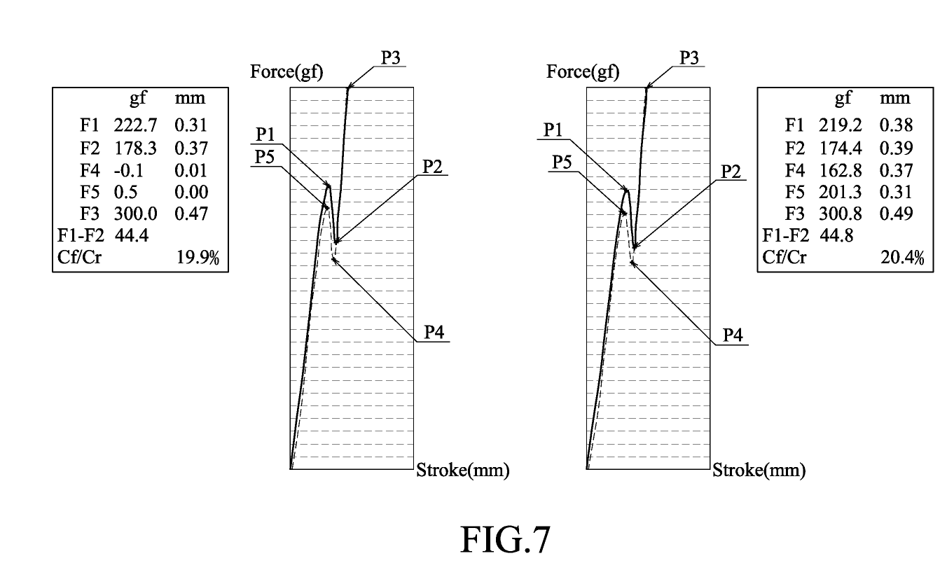

Further referring to FIGS. 6 and 7, some plots representing response curves of the conventional touch input device disclosed in the Taiwanese Invention Patent No. 1535366 and the touch input device of the present disclosure being touched are respectively shown. The touch sensing unit of the conventional touch input device includes left and right touch sensing modules. The two plots shown in FIG. 6 are the response curves of the left and right touch sensing modules of the conventional touch input device, and the two plots shown in FIG. 7 are the response curves of the left and right touch sensing modules 24 of the present disclosure. Each solid line represents a relationship between an exerted external force and a stroke of moving each touch sensing module downwardly when being touched or pressed, and each dashed line represents a relationship of the same when the external force is released. For each plot in FIGS. 6 and 7, point (P1) is a breakdown position where the external force exerted on each touch sensing module causes the supporting plate or the resilient arm to start bending, point (P2) is a position where the supporting plate or the resilient arm bends the most, point (P3) is a dead centre where the supporting plate or the resilient arm moved to the end of the stroke thereof, and force (F1)˜(F5) represent amounts of the force exerted on the supporting plate or the touch sensing module respectively at points (P1)˜(P5). A click ratio (Cf/Cr) for each touch sensing module can be calculated by multiplying a quotient of the difference between the values of the force (F1, F2) divided by the value of the force (F1) by 100%. A contact force for each touch sensing modules can be calculated by subtracting the value of the force (F2) from the force (F1). For the conventional touch input device, a contact force for the left and right touch sensing modules are respectively equal to 37.2 (calculated by subtracting 159.3 from 196.5) and 38.5 and the difference between the contact force for the left and right touch sensing modules is 1.3. Similarly, For the touch input device of the present disclosure, a contact force for the left and right touch sensing modules 24 are respectively equal to 44.4 and 44.8 and a difference therebetween is 0.4, which is smaller than that of the conventional touch input device. In this way, the touch input device of the present disclosure provides a relatively even sense of tactile to the user during use as compared to the conventional touch input device.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A touch input device comprising:
a base board unit that includes a first side rib extending in a first direction, a second side rib extending in the first direction and opposite to said first side rib in a second direction transverse to the first direction, a top surface, and a bottom surface, an intermediate portion disposed at a middle portion of said second side rib, two flanking portions flanking said intermediate portion and opposite to each other in the first direction, two slots extending through said top surface and said bottom surface and formed respectively through said flanking portions, and two resilient arms each of which extends from said intermediate portion into a corresponding one of said two slots; and
an upper board unit that is disposed on and above said base board unit, and that includes a first side connected to said first side rib of said base board unit and a second side corresponding in position to said second side rib of said base board unit and movable relative to said second side rib of said base board unit, and a pair of touch sensing modules respectively corresponding in position to and spaced apart from said resilient arms;
when an external force is exerted on one of said touch sensing modules, said one of said touch sensing modules is moved into contact with a corresponding one of said resilient arms such that the other one of said resilient arms supports the other one of said touch sensing modules by resilient deformation.

2. The touch input device as claimed in claim 1, wherein each of said resilient arms includes a connecting end connected to said intermediate portion and a free end opposite to said connecting end.

3. The touch input device as claimed in claim 2, wherein each of said resilient arms further includes an elongated plate segment extending from said intermediate portion and having said connecting end, and a contact segment extending from said elongated plate segment, having said free end, and disposed for contact with said touch sensing modules.

4. The touch input device as claimed in claim 2, wherein, for each of said resilient arms, said contact segment has a dimension greater than that of said elongated segment in the second direction.

5. The touch input device as claimed in claim 3, wherein said contact segment of each of said resilient arms has a circular plate portion extending from and coplanar with said elongated plate segment, and a protrusion extending from circular plate portion toward a corresponding one of said touch sensing modules for contact with the corresponding one of said touch sensing modules.

6. The touch input device as claimed in claim 1, wherein said slots and said resilient arms extend in the first direction.
